(19) United States
(12) Patent Application Publication
(10) Pub. No.: US 2019/0199171 A1
(43) Pub. Date: Jun. 27, 2019

(54) MOTOR

(71) Applicant: NIDEC CORPORATION, Kyoto (JP)

(72) Inventors: Shingo YOSHINO, Kyoto (JP); Tomoaki ANDO, Kyoto (JP); Masashi NOMURA, Kyoto (JP); Shinsuke HAMANO, Kyoto (JP)

(21) Appl. No.: 16/178,588

(22) Filed: Nov. 2, 2018

(30) Foreign Application Priority Data
Dec. 27, 2017 (JP) 2017-252099

(51) Int. Cl. H02K 9/193; H02K 5/08

(52) U.S. Cl. CPC H02K 9/193; H02K 3/46; H02K 5/08

(57) ABSTRACT

A motor includes a rotary portion including a shaft having a center on a vertically extending central axis. A bearing portion rotatably supports the shaft. A stationary portion includes a stator. The bearing portion is radially outward of the shaft and includes a sleeve bearing that contains a lubricating oil; and a housing radially outward of the sleeve bearing. The stator includes a stator core that is radially outward of the housing; and an insulator that covers at least part of the stator core. The insulator includes an upper insulating portion that covers an upper face of the stator core; a connecting portion that extends radially inward from the upper insulating portion; and an insulator inclined portion that is inclined in a direction away from the central axis, away from the connecting portion.

### CROSS REFERENCE TO RELATED APPLICATIONS

The present invention claims priority under 35 U.S.C. § 119 to Japanese Application No. 2017-252099 filed on Dec. 27, 2017 the entire content of which is incorporated herein by reference.

### FIELD

The present disclosure relates to a motor.

### BACKGROUND

A technique to prevent oil in a bearing of a motor from leaking has been known. Some motors include a stationary member that includes a radial bearing and a rotor includes a rotary shaft that is rotatably supported by the radial bearing and protrudes downward of the stationary member.

However, a radial bearing having a small volume, for example, can contain only a small amount of a lubricating oil. For this reason, a radial bearing having a small volume is likely to suffer influence, for example, the shortening of useful life, when the lubricating oil inside the radial bearing is reduced by the scattering of the lubricating oil resulting from the rotation of the motor, and other causes.

### SUMMARY

An exemplary motor of at least one embodiment includes a rotary portion; a bearing portion; and a stationary portion. The rotary portion includes a shaft having a center on a vertically extending central axis. The bearing portion rotatably supports the shaft. The stationary portion includes a stator. The bearing portion is radially outward of the shaft and includes a sleeve bearing that contains a lubricating oil; and a housing radially outward of the sleeve bearing. The stator includes a stator core that is radially outward of the housing; and an insulator that covers at least part of the stator core. The insulator includes an upper insulating portion that covers an upper face of the stator core; a connecting portion that extends radially inward from the upper insulating portion; and an insulator inclined portion that is inclined in a direction away from the central axis, downward from a radially inner end portion of the connecting portion.

The above and other elements, features, steps, characteristics and advantages of the present disclosure will become more apparent from the following detailed description of embodiments with reference to the attached drawings.

### BRIEF DESCRIPTION OF THE DRAWINGS

FIG. 1 is an exploded perspective view of a fan motor to which a motor according to at least one embodiment of the present disclosure is applied.

FIG. 2 is a vertical sectional view of the motor according to at least one embodiment of the present disclosure.

FIG. 3 is a sectional view of an upper portion of a bearing portion and surroundings in an enlarged manner according to at least one embodiment of the present disclosure.

FIG. 4 is a plan view of a second member according to at least one embodiment of the present disclosure.

FIG. 5 is a perspective view of a housing according to at least one embodiment of the present disclosure.

FIG. 6 is a view of a circulation model of a lubricating oil contained in a sleeve bearing according to at least one embodiment of the present disclosure.

FIG. 7 is a horizontal sectional view of the housing according to at least one embodiment of the present disclosure.

FIG. 8 is a schematic view of a position to apply an oil repellent agent according to at least one embodiment of the present disclosure.

FIG. 9 is a schematic sectional view of a motor of at least one embodiment of the present disclosure.

FIG. 10 is a schematic sectional view of a motor of at least one embodiment of the present disclosure.

FIG. 11 is a schematic sectional view of a motor of at least one embodiment of the present disclosure.

### DETAILED DESCRIPTION

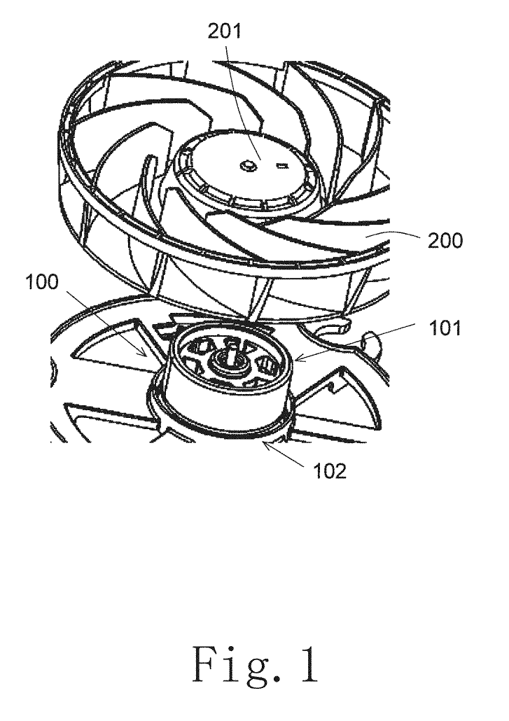

Hereinafter, at least one embodiment of the present disclosure will be described with reference to the drawings. FIG. 1 is an exploded perspective view of a fan motor to which a motor 100 according to at least one embodiment of the present disclosure is applied. FIG. 1 shows part of the fan motor in an enlarged manner. In FIG. 1, the motor 100 is attached to a blade portion 200. The blade portion 200 is fixed to a rotary portion 101 of the motor 100 and rotates along with the rotation of the rotary portion 101. Note that the motor 100 may be applied to applications other than the fan motor. The rotary portion 101 may be equipped with a member other than blades.

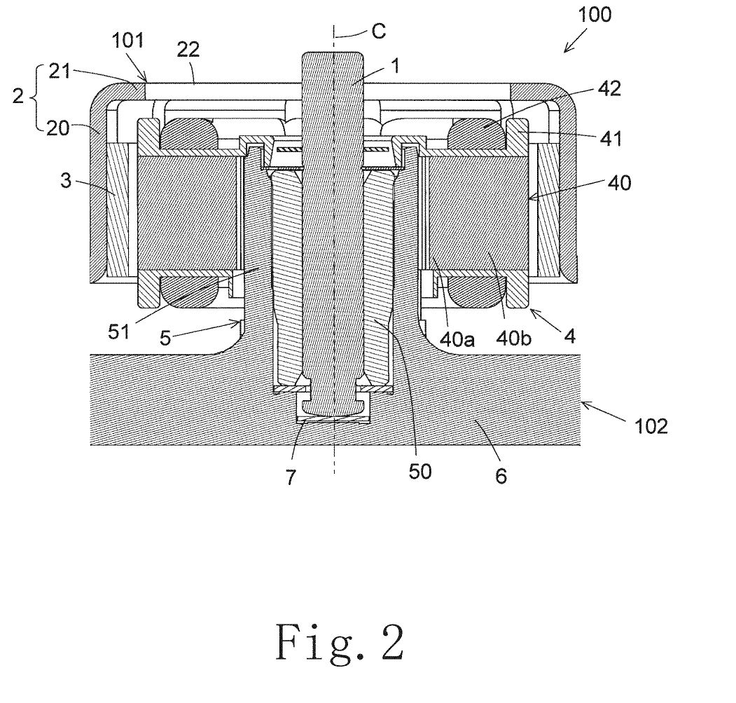

In the present Specification, “axial”, “axially”, and “axial direction” refer to a direction parallel with a central axis C of the motor 100, in FIG. 2; “radial”, “radially”, and “radial direction”, a direction orthogonal to the central axis C; “circumferential”, “circumferentially”, and “circumferential direction”, a direction extending along an arc about the central axis C. In addition, in the present Specification, shapes and positional relations of the portions will be described on the assumption that the axial direction is equivalent to the vertical direction and the side on which the blade portion 200 is attached to the motor 100 is the upper side. One of ordinary skill in the art would understand that the definition of the vertical direction is not intended to limit the direction in which the motor 100 is used.

FIG. 2 is a vertical sectional view of the motor 100 according to at least one embodiment of the present disclosure. In FIGS. 1 and 2, the motor 100 includes a rotary portion 101 and a stationary portion 102. The motor 100 is a so-called outer rotor-type motor.

The rotary portion 101 includes a shaft 1. The shaft 1 has a center on the vertically extending central axis C. In at least one embodiment, the shaft 1 is a columnar member comprising a metal. The shaft 1 may however have a different shape such as a cylindrical shape, for example. The shaft 1 may comprise a material other than a metal. In at least one embodiment, the blade portion 200, in FIG. 1, is fixed to an upper end of the shaft 1.

The rotary portion 101 further includes a rotor holder 2 and a magnet 3. The rotor holder 2 includes a rotor cylinder portion 20 and a rotor lid portion 21. The rotor cylinder portion 20 and the rotor lid portion 21 are formed of a single metal member. The rotor cylinder portion 20 is cylindrical about the central axis C. The rotor lid portion 21 is located at an upper end portion of the rotor cylinder portion 20 and is annular about the central axis C. A circular opening 22 is provided in an upper face of the rotor holder 2.

In at least one embodiment, the rotor holder 2 is fixed to the blade portion 200. Since the blade portion 200 is fixed to the shaft 1, the rotor holder 2 is fixed to the shaft 1 as a consequence. That is, the rotor holder 2 and the shaft 1 rotate integrally. Specifically, a boss portion 201 which has a lidded cylindrical shape and is open downward is provided on a central portion of the blade portion 200. The rotor cylinder portion 20 is housed and fixed inside the boss portion 201. The method of fixing the rotor cylinder portion 20 and the boss portion 201 is not particularly limited. For example, the fixation may be achieved by press-fitting or bonding. The rotor holder 2 may be directly fixed to the shaft 1 with the size of the opening 22 being reduced. The rotor holder 2 may be indirectly fixed to the shaft 1 by means of an attachment member to be fixed to the shaft 1.

The magnet 3 is fixed to an inner peripheral surface of the rotor holder 2. Specifically, the magnet 3 is fixed to the inner peripheral surface of the rotor cylinder portion 20 using adhesive, for example. In at least one embodiment, the magnet 3 is annular about the central axis C. The magnet 3 may alternatively be formed of a plurality of magnet pieces arranged circumferentially at intervals about the central axis C.

The stationary portion 102 includes a stator 4 and a bearing portion 5. The stator 4 is annular about the central axis C. The stator 4 is disposed radially inward of the magnet 3. The stator 4 is an armature that generates magnetic flux in accordance with a drive current. The stator 4 includes a stator core 40 and an insulator 41. The stator 4 further includes a coil 42.

The stator core 40 is a magnetic body. The stator core 40 is formed by stacking electrical steel sheets for example. The stator core 40 is disposed radially outward of the housing 51. The housing 51 will be described later. The stator core 40 includes an annular core back 40a and a plurality of teeth 40b. An inner peripheral surface of the core back 40a is fixed to the bearing portion 5. The plurality of teeth 40b protrude radially outward from the core back 40a. The plurality of teeth 40b are arranged circumferentially about the central axis C at intervals. The plurality of teeth 40b are arranged circumferentially at equal intervals.

The insulator 41 covers at least part of the stator core 40. The insulator 41 is an insulating body. As the material for the insulator 41, a resin is used, for example. The coil 42 is formed by winding a conductive wire around each of the teeth 40b with the insulator 41 in between. The stator 4 includes a plurality of the coils 42.

The bearing portion 5 rotatably supports the shaft 1. The bearing portion 5 includes a sleeve bearing 50 and a housing 51. The sleeve bearing 50 contains lubricating oil. The sleeve bearing 50 is a sintered body formed by sintering a metal powder, for example. The sleeve bearing 50 is a porous member and has a plurality of fine holes containing the lubricating oil therein. The sleeve bearing 50 is cylindrical about the central axis C. The sleeve bearing 50 is disposed radially outward of the shaft 1. The shaft 1 is inserted through the cylindrical sleeve bearing 50.

The housing 51 is disposed radially outward of the sleeve bearing 50. The housing 51 is cylindrical about the central axis C. The sleeve bearing 50 is placed inside the housing 51 and fixed to the housing 51. The sleeve bearing 50 is fixed to an inner peripheral surface of the housing 51 by press-fitting, for example. A lower end portion of the housing 51 is closed. In at least one embodiment, the housing 51 is part of the same member as that of a base portion 6 expanding radially from the central axis C, and a lower face of the housing 51 is closed by part of the base portion 6. However, the lower face side of the housing 51 may be closed by a member different from the base portion 6. The shaft 1 rotates while being in contact with a thrust plate 7, which is disposed in a lower portion of the housing 51. In at least one embodiment, the lubricating oil is in the axial gap between the shaft 1 and the thrust plate 7.

A rotational torque is generated between the magnet 3 and the stator 4 by supplying the drive current to the stator 4. This causes the rotor holder 2 to rotate relative to the stator 4. The rotor holder 2 rotates together with the shaft 1 about the central axis C. In at least one embodiment, the blade portion 200 rotates about the central axis C along with the rotation of the rotor holder 2.

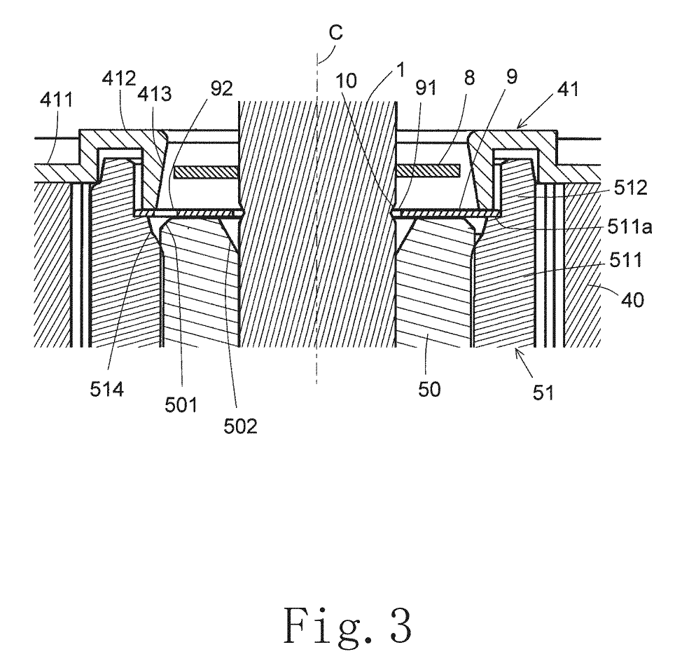

FIG. 3 is a sectional view of an upper portion of the bearing portion 5 and surroundings in an enlarged manner according to at least one embodiment. FIG. 3 is an enlarged view of part of FIG. 2. In FIG. 3, the shaft 1 holds a first member 8. The first member 8 is disposed above the sleeve bearing 50. Specifically, the first member 8 is disposed axially away from the sleeve bearing 50. The first member 8 expands radially outward from the outer peripheral surface of the shaft 1.

Specifically, the first member 8 is a flat plate member that is annular about the central axis C. In at least one embodiment, the first member 8 has a circular outer periphery in a plan view as viewed in the axial direction. However, the first member 8 may have an outer periphery of another shape such as a polygonal shape or an elliptical shape in the plan view as viewed in the axial direction. In at least one embodiment, the first member 8 comprises a metal and is press-fitted onto the shaft 1. However, the first member 8 may be formed of a material other than a metal, such as a resin. The first member 8 may be fixed to the shaft 1 using adhesive or the like. When the lubricating oil leaks from inside the sleeve bearing 50 and moves upward along the shaft 1, the first member 8 helps to prevent the lubricating oil from scattering due to the rotation of the shaft 1.

The housing 51 holds a second member 9. The second member 9 is disposed above the sleeve bearing 50 and below the first member 8. The second member 9 may be disposed axially away from the sleeve bearing 50. In at least one embodiment, the second member 9 is disposed as close as possible to the sleeve bearing 50. The second member 9 may be in contact with the sleeve bearing 50. The first member 8 and the second member 9 axially face each other with a gap in between.

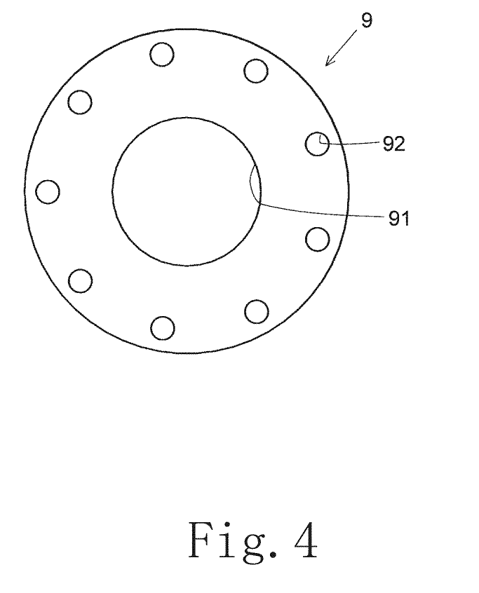

The second member 9 expands radially inward from the inner peripheral surface of the housing 51. FIG. 4 is a plan view of the second member 9 according to at least one embodiment. In FIGS. 3 and 4, the second member 9 is a flat plate member that is annular about the central axis C. In at least one embodiment, the second member 9 has a circular outer periphery in a plan view as viewed in the axial direction. However, the second member 9 may have an outer periphery of another shape such as a polygonal shape or an elliptical shape in the plan view as viewed in the axial direction. In at least one embodiment, the second member 9 comprises a metal. However, the second member 9 may be formed of another material such as a resin.

In FIG. 4, the second member 9 includes a first hole 91 and at least one second hole 92. The first hole 91 axially penetrates therethrough and is circular about the central axis C. However, the shape of the first hole 91 is not limited to a circular shape, but may be another shape such as polygonal shape or an elliptical shape. The first hole 91 is a hole through which to insert the shaft 1.

The second hole 92 is disposed radially outward of the first hole 91. The second hole 92 axially penetrates therethrough. In at least one embodiment, the second member 9 includes a plurality of the second holes 92. The plurality of second holes 92 are arranged circumferentially at intervals about the central axis C. Specifically, the plurality of second holes 92 are arranged circumferentially at equal intervals. In at least one embodiment, each of the second holes 92 is circular. However, each second hole 92 may have another shape such as a polygonal shape or an elliptical shape. Each second hole 92 may be arranged concentrically in part in the circumferential direction. In addition, each second hole 92 may have a cut shape cutting inward from an outer edge of the second member 9.

Since the second member 9 covers the upper side of the sleeve bearing 50, vaporization of the lubricating oil contained in the sleeve bearing 50 is suppressed. In addition, since the second holes 92 are provided in the second member 9, the lubricating oil repelled by the first member 8 or an insulator inclined portion 413 of the insulator 41 can be returned into the sleeve bearing 50 through the second holes 92. Note that the second member 9 is disposed above the sleeve bearing 50 and below the insulator inclined portion 413. The insulator inclined portion 413 will be described later.

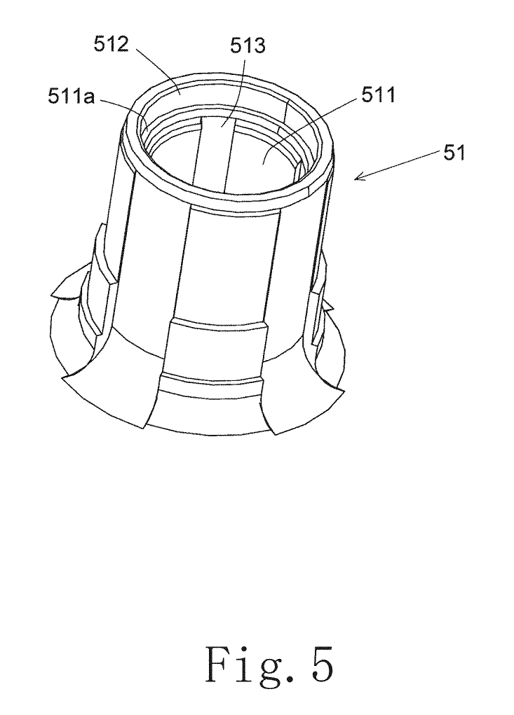

FIG. 5 is a perspective view of the housing 51 according to at least one embodiment. In FIGS. 3 and 5, the housing 51 includes a first cylinder portion 511 and a second cylinder portion 512. The first cylinder portion 511 and the second cylinder portion 512 are cylindrical about the central axis C. The first cylinder portion 511 radially faces the sleeve bearing 50. The second cylinder portion 512 is disposed above the first cylinder portion 511, and has an inner diameter larger than that of the first cylinder portion 511. The difference in inner diameter between the first cylinder portion 511 and the second cylinder portion 512 provides an upper face 511a of the first cylinder portion 511 in the housing 51. The second member 9 is disposed on the upper face 511a of the first cylinder portion 511. The upper face 511a is usable to position the second member 9 and to easily attach the second member 9 to the housing 51.

In FIG. 3, the insulator 41 includes an upper insulating portion 411, a connecting portion 412, and the insulator inclined portion 413. The upper insulating portion 411 covers an upper face of the stator core 40. In at least one embodiment, the upper insulating portion 411 has an annular portion which covers the core back 40a. The connecting portion 412 extends radially inward from the upper insulating portion 411. In at least one embodiment, the connecting portion 412 is annular about the central axis C, and is connected to the annular portion of the upper insulating portion 411. The insulator inclined portion 413 is inclined in a direction away from the central axis C, downward from a radially inner end portion of the connecting portion 412. In at least one embodiment, the insulator inclined portion 413 is over the entire periphery in the circumferential direction about the central axis C. However, the insulator inclined portion 413 may be configured to be provided partially in the circumferential direction. The shapes of the upper insulating portion 411 and the connecting portion 412 may be changed in conformity with the configuration of the insulator inclined portion 413. In at least one embodiment, the insulator inclined portion 413 forms an inner peripheral surface of a cylindrical portion provided downward of the connecting portion 412.

The insulator inclined portion 413 may be a planar surface or a curved surface. The insulator inclined portion 413 may have both of a planar surface and a curved surface. The radially opposite surface of the insulator inclined portion 413 is parallel with the axial direction. However, the radially opposite surface of the insulator inclined portion 413 may be an inclined surface which is inclined relative to the axial direction. This inclined surface may be parallel with the insulator inclined portion 413. Alternatively, the insulator inclined portion 413 may be a surface having a step shape, which is at least partially stepwise.

The insulator inclined portion 413 helps to return the lubricating oil having scattered along with the rotation of the shaft 1 into the sleeve bearing 50 by causing the lubricating oil to hit the insulator inclined portion 413. In addition, in a case where the motor 100 is arranged in such an orientation that the axial direction becomes horizontal, the lubricating oil is returned into the sleeve bearing 50 along the insulator inclined portion 413 by utilizing the weight of the lubricating oil itself. In other words, the lubricating oil which has hit the insulator inclined portion 413 is prevented from falling down with the weight of the lubricating oil from an end portion of the insulator inclined portion 413 on the axially opposite side to that where the sleeve bearing 50 is provided. In at least one embodiment, the insulator inclined portion 413 and the second cylinder portion 512 are placed radially over each other. This arrangement helps to prevent the lubricating oil from scattering with the second cylinder portion 512 in addition to the insulator inclined portion 413, and thus to reduce the possibility of leakage of the lubricating oil outside the housing 51.

At least part of the insulator inclined portion 413 may be placed axially over an upper face of the sleeve bearing 50. In at least one embodiment, the insulator inclined portion 413 is placed axially over a radially outer end of the sleeve bearing 50. In at least one embodiment, a lower end of the insulator inclined portion 413 is located downward of the first member 8 and be located upward of the second member 9. The arrangement helps to cause the lubricating oil repelled by the first member 8 to hit the insulator inclined portion 413 and be directed to the second member 9. In at least one embodiment, the first member 8 is located above a lower end of the insulator inclined portion 413 and above the sleeve bearing 50. This arrangement helps to cause the lubricating oil repelled by the first member 8 to hit the insulator inclined portion 413 and be returned into the sleeve bearing 50.

In at least one embodiment, the lower end of the insulator inclined portion 413 is in contact with an upper face of the second member 9. This arrangement helps to easily fix the second member 9 to the housing 51 by pressing the second member 9 with the insulator inclined portion 413. However, the second member 9 may be fixed to the housing 51 by press-fitting or bonding, for example. In this case, the lower end of the insulator inclined portion 413 may face the second member 9 axially with a gap in between. In this case as well, the insulator inclined portion 413 can suppress the inclined placement of the second member 9 relative to the radial direction.

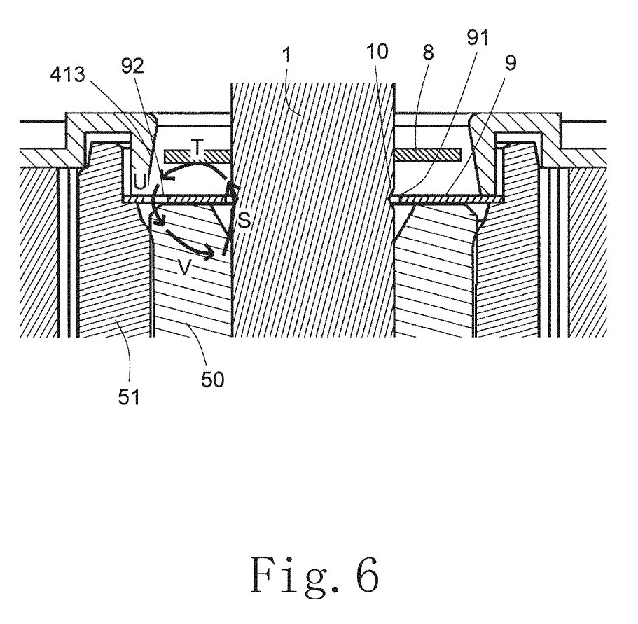

According to at least one embodiment, the lubricating oil contained in the sleeve bearing 50 circulates in accordance with a model shown by arrows in FIG. 6. FIG. 6 is a diagram of the circulation model of the lubricating oil contained in the sleeve bearing 50 according to at least one embodiment. The arrow S in FIG. 6 indicate the lubricating oil leaked from inside the sleeve bearing 50 to the inner peripheral surface side of the sleeve bearing 50 along with the rotation of the shaft 1 moves along the surface of the shaft 1 to the upper portion of the shaft 1. In this event, the lubricating oil passes through the first hole 91. In FIG. 3, the shaft 1 has a groove portion 10 in its outer peripheral surface. The groove portion 10 is radially depressed. The shape of the groove portion 10 may be a V shape, a U shape, or the like. The groove portion 10 radially faces the inner peripheral surface which constitutes the first hole 91 of the second member 9 with a gap in between. This allows the lubricating oil which leaks from inside the sleeve bearing 50 and runs on the shaft 1 to be held by the groove portion 10 thanks to the action of surface tension. Accordingly, the amount of the lubricating oil to scatter along with the rotation of the shaft 1 is reduced.

The arrow T in FIG. 6 indicates the lubricating oil having moved to the upper portion of the shaft 1 scatters due to the rotation of the shaft 1 and hits the first member 8 or the insulator inclined portion 413 to be directed toward the second member 9. The arrow U in FIG. 6 indicates the lubricating oil directed toward the second member 9 passes through the second hole 92 and returns into the sleeve bearing 50. The arrow V in FIG. 6 indicates the lubricating oil having returned into the sleeve bearing 50 again leaks toward the inner peripheral surface side of the sleeve bearing 50 and is positioned between the sleeve bearing 50 and the shaft 1 to reduce friction. Since the cycle of the arrows S to V is repeated, reduction of the lubricating oil inside the sleeve bearing 50 is suppressed. Consequently, the useful life of the sleeve bearing 50 is increased.

In at least one embodiment, at least the lower end portion of the first member 8 is located radially inward of the insulator 41. In at least one embodiment, at least the lower end portion of the first member 8 faces the insulator 41 radially. In at least one embodiment, at least the lower end portion of the first member 8 is located radially inward of the insulator inclined portion 413. This arrangement helps to suppress excessive increase in axial distance between the first member 8 and the second member 9. Accordingly, the lubricating oil scattering along with the rotation of the shaft 1 is efficiently returned to the sleeve bearing 50 through the second hole 92. In at least one embodiment, as in FIG. 3, the entirety of the first member 8 is located radially inward of the insulator 41.

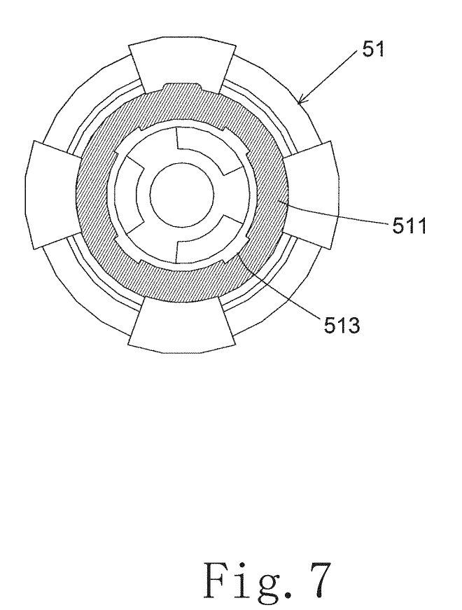

Next, a mode regarding the positional relations of the first hole 91 and the second hole 92 with the other members will be described according to at least one embodiment. FIG. 7 is a horizontal sectional view of the housing 51 according to at least one embodiment. In FIGS. 5 and 7, the inner peripheral surface of the first cylinder portion 511 includes a housing depressed portion 513 which is depressed radially. The housing depressed portion 513 extends axially. At the position where the housing depressed portion 513 is provided, the inner peripheral surface of the first cylinder portion 511 and the outer peripheral surface of the sleeve bearing 50 radially face each other with a gap in between. In at least one embodiment, the second hole 92 is located upward of a radially outer end surface of the sleeve bearing 50. In at least one embodiment, the second hole 92 and the radially outer end surface of the sleeve bearing 50 are placed axially over each other. This arrangement helps to guide the lubricating oil having passed through the second hole 92 to the radial gap between the sleeve bearing 50 and the housing 51. The lubricating oil having entered between the sleeve bearing 50 and the housing 51 can be returned into the sleeve bearing 50. Accordingly, reduction of the lubricating oil in the sleeve bearing 50 is suppressed.

In at least one embodiment, the region where the second hole 92 is placed axially over the sleeve bearing 50 is not too large. For example, in at least one embodiment, part of the opening portion of the second hole 92 is placed over the sleeve bearing 50. This arrangement helps to efficiently prevent the lubricating oil from vaporizing from the sleeve bearing 50 with the second member 9.

In FIG. 3, the sleeve bearing 50 has a first bearing inclined portion 501 which increases in axial height radially from outside to inside, on a radially outer side of the upper end portion. The first bearing inclined portion 501 may be a planar surface or a curved surface. The first bearing inclined portion 501 may have both of a planar surface and a curved surface. In at least one embodiment, the first bearing inclined portion 501 is provided over the entire periphery in the circumferential direction. In at least one embodiment, the second hole 92 is located upward of the first bearing inclined portion 501. In at least one embodiment, the second hole 92 and the first bearing inclined portion 501 are placed axially over each other. The entirety of the second hole 92 may be placed axially over the first bearing inclined portion 501. Part of the second hole 92 may be placed axially over the first bearing inclined portion 501. In at least one embodiment, an upper end of the first bearing inclined portion 501 is placed axially over the second hole 92.

According to at least one embodiment, the lubricating oil having passed through the second hole 92 is guided to the first bearing inclined portion 501. The lubricating oil having been guided to the first bearing inclined portion 501 can return into the sleeve bearing 50 directly, or after entering the radial gap between the sleeve bearing 50 and the housing 51. Accordingly, reduction of the lubricating oil in the sleeve bearing 50 is suppressed.

In FIG. 3, the sleeve bearing 50 has a second bearing inclined portion 502 which increases in axial height radially from inside to outside, on a radially inner side of the upper end portion thereof. The second bearing inclined portion 502 may be a planar surface or a curved surface. The second bearing inclined portion 502 may have both of a planar surface and a curved surface. In at least one embodiment, the second bearing inclined portion 502 is provided over the entire periphery in the circumferential direction. In at least one embodiment, an upper end of the second bearing inclined portion 502 is located radially outward of the first hole 91. This arrangement helps to suppress passing of the lubricating oil having leaked from inside the sleeve bearing 50 through the second member 9 via the first hole 91. This arrangement also helps to insert the shaft 1 into the hole of the sleeve bearing 50 with the second bearing inclined portion 502 and to insert the shaft 1 into the sleeve bearing 50.

In FIG. 3, the first cylinder portion 511 has a housing inclined portion 514 which increases in axial height radially from inside to outside, on a radially inner side of the upper end portion thereof. The housing inclined portion 514 may be a planar surface or a curved surface. The housing inclined portion 514 may have both of a planar surface and a curved surface. In at least one embodiment, the housing inclined portion 514 is provided over the entire periphery in the circumferential direction. In at least one embodiment, the housing inclined portion 514 is located downward of the second hole 92. In at least one embodiment, the second hole 92 and the housing inclined portion 514 are placed axially over each other. The entirety of the second hole 92 may be placed axially over the housing inclined portion 514. Part of the second hole 92 may be placed axially over the housing inclined portion 514.

According to at least one embodiment, the lubricating oil having passed through the second hole 92 is guided to the housing inclined portion 514. The lubricating oil having been guided to the housing inclined portion 514 can return into the sleeve bearing 50 directly, or after entering the radial gap between the sleeve bearing 50 and the housing 51. Accordingly, reduction of the lubricating oil in the sleeve bearing 50 is suppressed.

In FIG. 3, a radially inner end of the lower end of the insulator inclined portion 413 is preferably located upward of the second hole 92. In at least one embodiment, the radially inner end of the lower end of the insulator inclined portion 413 and the second hole 92 are placed axially over each other. This arrangement helps to easily guide the lubricating oil running on the insulator inclined portion 413 to the second hole 92. The lubricating oil having been guided to the second hole 92 can return into the sleeve bearing 50 through the second hole 92. Accordingly, reduction of the lubricating oil in the sleeve bearing 50 is suppressed.

In at least one embodiment, an oil repellent agent which repels the lubricating oil is applied to at least part of the surface of at least one of the first member 8, the second member 9, the insulator 41, and the housing 51. The type of the oil repellent agent is not particularly limited. However, in at least one embodiment, the oil repellent agent has such a characteristic that the oil repellent agent is unlikely to undergo chemical changes with the lubricating oil. In at least one embodiment, the oil repellent agent has such a characteristic that the oil repellent agent is unlikely to affect the properties such as viscosity of the lubricating oil. Applying the oil repellent agent makes the lubricating oil having leaked from inside the sleeve bearing 50 unlikely to adhere to a member other than the sleeve bearing 50, and thus helps to efficiently return the lubricating oil into the sleeve bearing 50.

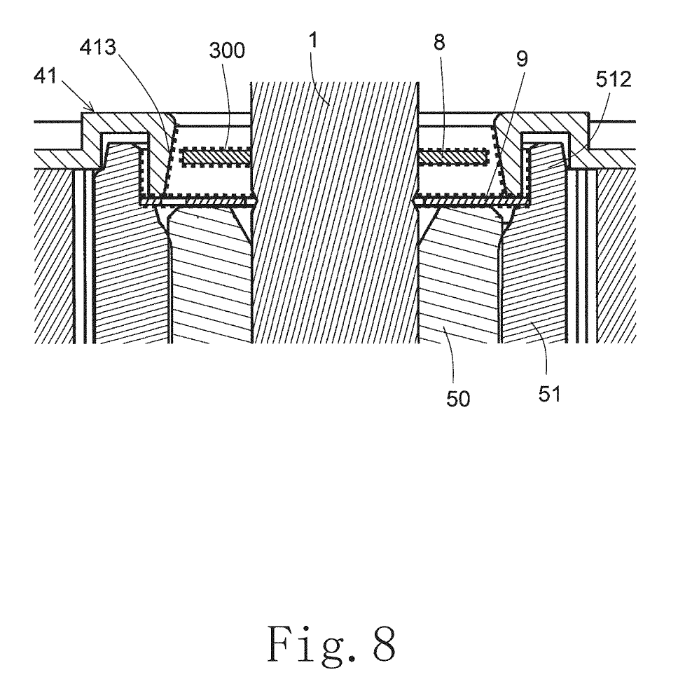

FIG. 8 is a schematic view of a position to apply the oil repellent agent 300 according to at least one embodiment. The thick dashed line in FIG. 8 indicates the position to apply the oil repellent agent 300. In the example shown in FIG. 8, the oil repellent agent is applied at least part of the surfaces of all of the first member 8, the second member 9, the insulator 41, and the housing 51. In at least one embodiment, the application of the oil repellent agent to each member is carried out for each member before each member is incorporated into the motor 100. This helps to reduce the workload to apply the oil repellent agent 300. In addition, the oil repellent agent 300 is prevented from adhering to an undesirable portion during the application work.

In at least one embodiment the oil repellent agent 300 is applied to at least one of the upper face and the lower face of the first member 8. In FIG. 8, the oil repellent agent 300 is applied to the upper face and the lower face of the first member 8. Since the first member 8 is a rotary body, applying the oil repellent agent to at least one of the upper face and the lower face of the first member 8 allows the lubricating oil to be flown to the insulator inclined portion 413 by centrifugal force. Thereafter, the lubricating oil can run on the insulator inclined portion 413 to return from the second hole 92 into the sleeve bearing 50.

The oil repellent agent 300 may be applied to at least one of the upper face and the lower face of the second member 9. In FIG. 8, the oil repellent agent 300 is applied to both of the upper face and the lower face of the second member 9. The oil repellent agent 300 may be applied to the inner peripheral surface of the first hole 91 or the second hole 92. In FIG. 8, the oil repellent agent 300 may be applied to the inner peripheral surface of the second cylinder portion 512.

In FIG. 8, the oil repellent agent 300 which repels the lubricating oil is applied to the surface of the insulator inclined portion 413. Applying the oil repellent agent 300 to the insulator inclined portion 413 helps to repel the lubricating oil having scattered along with the rotation of the shaft 1 with the insulator inclined portion 413 to return the lubricating oil from the second hole 92 into the sleeve bearing 50.

In at least one embodiment, the oil repellent agent 300 is not applied to the surface of the shaft 1. If the oil repellent agent 300 were applied to the surface of the shaft 1, maintaining the lubricating oil radially between the shaft 1 and the sleeve bearing 50 would be difficult, where the lubricating oil is required for reducing the friction. This configuration is to avoid such a situation. One of ordinary skill in the art would understand that the oil repellent agent may be applied to a portion of the shaft 1 above the sleeve bearing 50. However, since there is a possibility that the oil repellent agent 300 adheres to an undesirable portion of the shaft 1 during the application work, the oil repellent agent 300 is not applied to the shaft 1 according to at least one embodiment.

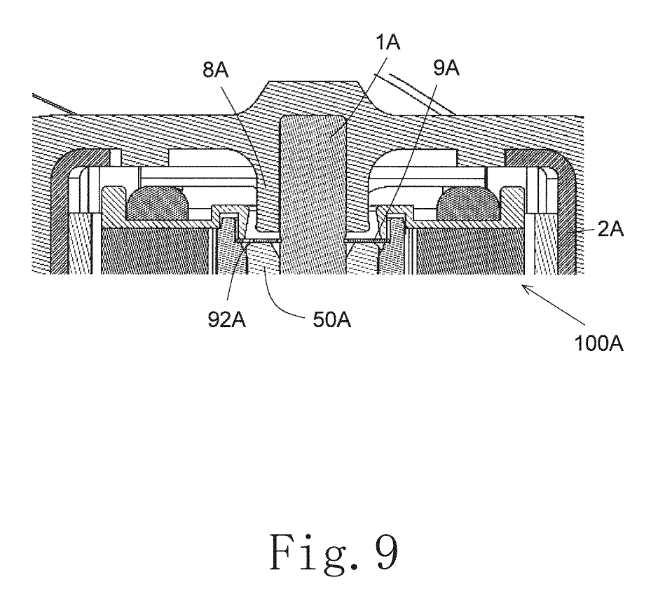

FIG. 9 is a schematic sectional view of a motor 100A of at least one embodiment. The motor 100A includes a first member 8A disposed above a sleeve bearing 50A which contains a lubricating oil. The first member 8 expands radially from an outer peripheral surface of a shaft 1A. The first member 8A axially faces a second member 9A which includes a second hole 92A.

The first member 8A is a member that is attached to an upper portion of the shaft 1A and fixed to a rotor holder 2A. In at least one embodiment, the first member 8A is a boss portion of blades to be attached to the motor 100A. However, the first member 8A may be a member separate from the blades, and may be for example a coupling member, or the like, provided only for coupling the shaft 1A and the rotor holder 2A. In at least one embodiment, scattering of the lubricating oil along with the rotation of the shaft 1A is suppressed with the first member 8A.

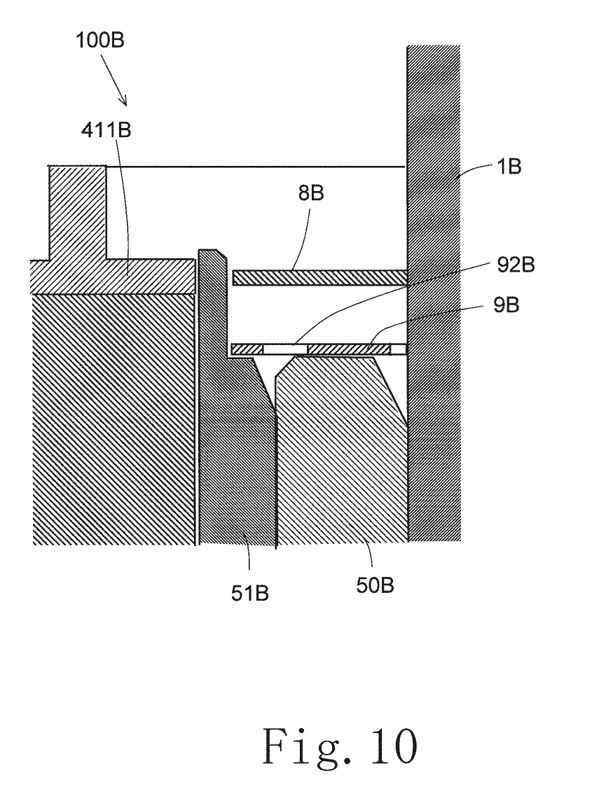

FIG. 10 is a schematic sectional view of a motor 100B of at least one embodiment. The motor 100B includes an upper insulating portion 411B, but does not include the insulator inclined portion 413 or the connecting portion 412 in the motor 100. In at least one embodiment, the configuration does not including the insulator inclined portion 413, in the motor 100B, because a first member 8B has a large radius. A radially outer end of the first member 8B is located radially outward of a radially outer end of a sleeve bearing 50B. The first member 8B extends to near an inner peripheral surface of a housing 51B. With such a configuration as well, the lubricating oil having scattered along with the rotation of the shaft 1B hits the first member 8B, is directed to the second member 9B, and is returned into the sleeve bearing 50B through the second hole 92B.

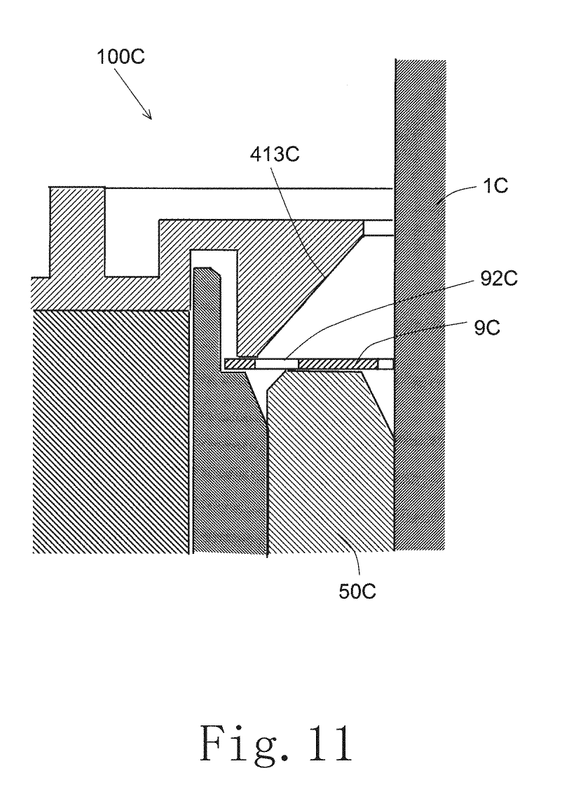

FIG. 11 is a schematic sectional view of a motor 100C of at least one embodiment. The motor 100C does not include the first member 8 in the motor 100 of the above-described embodiment. In at least one embodiment, the motor 100C includes an inclination angle of an insulator inclined portion 413C is larger than that of the insulator inclined portion 413 of motor 100. A large part of the insulator inclined portion 413C is placed axially over the upper face of a sleeve bearing 50C. A radially inner end of the insulator inclined portion 413C is located radially inward of a radially inner end of the second hole 92C. This helps to efficiently cause the lubricating oil having scattered along with the rotation of the shaft 1C to hit the insulator inclined portion 413C, be directed toward the second member 9C, and be returned into the sleeve bearing 50C through the second hole 92C.

One of ordinary skill in the art would understand that in the configuration of motor 100C, the second member 9C may be omitted. In this case as well, the lubricating oil having scattered along with the rotation of the shaft 1C hits the insulator inclined portion 413C and is returned into the sleeve bearing 50C. However, providing the second member 9C helps to reduce a larger amount of the lubricating oil to vaporize from the sleeve bearing 50C than otherwise.

For example, although in the above, the structure for circulating the lubricating oil is provided only on one side in the axial direction, the structure for circulating the lubricating oil may be provided axially on either side.

The present disclosure may be utilized in motors included in home electronics, office automation equipment, on-vehicle equipment, and the like.

Features of the above-described embodiments and the modifications thereof may be combined appropriately as long as no conflict arises.

While embodiments of the present disclosure have been described above, one of ordinary skill in the art would understand that variations and modifications will be apparent to those skilled in the art without departing from the scope and spirit of the present disclosure. The scope of the present disclosure, therefore, is to be determined solely by the following claims.

What is claimed is:

1. A motor comprising:
a rotary portion comprising a shaft having a center on a vertically extending central axis; and
a stationary portion comprising a stator and a bearing portion rotatably supporting the shaft, wherein
the bearing portion comprises:
a sleeve bearing radially outward of the shaft, wherein the sleeve bearing contains a lubricating oil; and
a housing radially outward of the sleeve bearing,
the stator comprises:
a stator core radially outward of the housing; and
an insulator that covers at least part of the stator core,
the insulator comprises:
an insulating portion that covers a face of the stator core;
a connecting portion that extends radially inward from the insulating portion; and
an insulator inclined portion that is inclined in a direction away from the central axis.

2. The motor according to claim 1, further comprising
a first member attached to the shaft, wherein the first member extends radially outward from an outer peripheral surface of the shaft, and
the first member is axially displaced from an end of the insulator inclined portion farthest from the connecting portion in a first direction.

3. The motor according to claim 2, wherein
an end portion of the first member is radially inward of the insulator inclined portion.

4. The motor according to claim 2, further comprising
a second member attached to the housing, wherein the second member is axially between the sleeve bearing and the first member, and a gap is defined between the first member and the second member, and
the second member comprises:
a first hole surrounding the shaft; and
at least one second hole radially outward from the first hole, wherein each of the at least one second hole penetrates through the second member.

5. The motor according to claim 1, further comprising
a second member attached to the housing, wherein the second member is axially between the sleeve bearing and the insulator inclined portion, and
the second member comprises:
a first hole surrounding the shaft; and
at least one second hole radially outward from the first hole, wherein each of the at least one second hold penetrates through the second member.

6. The motor according to claim 4, wherein
an end of the insulator inclined portion farthest from the connecting portion is in contact with an upper face of the second member.

7. The motor according to claim 4, wherein
a radially inner side of an end of the insulator inclined portion farthest from the connecting portion is axially displaced from the at least one second hole in the first direction.

8. The motor according to claim 4, wherein
each of the at least one second hole is axially displaced from a radially outer end surface of the sleeve bearing in the first direction.

9. The motor according to claim 4, wherein
the sleeve bearing comprises a bearing inclined portion that increases in axial height radially from outside to inside, on a radially outer side of an end portion thereof, and
the at least one second hole is axially displaced from the bearing inclined portion in the first direction.

10. The motor according to claim 4, wherein
the shaft comprises a groove portion in an outer peripheral surface thereof, and
the groove portion radially faces an inner surface of the first hole of the second member with a second gap in between.

11. The motor according to claim 4, wherein
the sleeve bearing comprises a bearing inclined portion that increases in axial height radially from inside to outside, on a radially inner side of an upper end portion thereof, and
an end of the bearing inclined portion is radially outward of the first hole.

12. The motor according to claim 4, wherein
an oil repellent agent that repels the lubricating oil on at least part of a surface of at least one of the first member, the second member, the insulator, or the housing.

13. The motor according to claim 12, wherein
the lubricating oil is on a surface of the insulator inclined portion.

14. The motor according to claim 2, wherein
an oil repellent agent that repels the lubricating oil is on at least one of a first surface or a second surface of the first member, wherein the first surface is axially displaced from the second surface.

15. The motor according to claim 4, wherein
the housing comprises:
a first cylinder portion surrounding the sleeve bearing; and
a second cylinder portion axially displaced from the first cylinder portion in the first direction, wherein the second cylinder has an inner diameter larger than an inner diameter of the first cylinder portion, and
the second member is on a face of the first cylinder portion.

16. The motor according to claim 4, wherein
the housing comprises:
a first cylinder portion surrounding the sleeve bearing; and
a second cylinder portion axially displaced from the first cylinder portion in the first direction, wherein the second cylinder has an inner diameter larger than an inner diameter of the first cylinder portion,
the first cylinder portion comprises a housing inclined portion that increases in axial height radially from inside to outside, on a radially inner side of an upper end portion thereof, and
the housing inclined portion is axially displaced from the at least one second hole in a second direction opposite the first direction.

17. The motor according to claim 1, wherein
the housing includes:
a first cylinder portion surrounding the sleeve bearing; and
a second cylinder portion axially displaced from the first cylinder portion in a first direction, wherein the second cylinder has an inner diameter larger than an inner diameter of the first cylinder portion, and
the insulator inclined portion and the second cylinder portion are radially over each other.
